(19) United States
(12) Patent Application Publication
(10) Pub. No.: US 2016/0259045 A1
(43) Pub. Date: Sep. 8, 2016

(54) Wideband Ground Penetrating Radar System and Method

(71) Applicant: Dryver R. Huston, South Burlington, VT (US)

(72) Inventor: Dryver R. Huston, South Burlington, VT (US)

(21) Appl. No.: 15/063,369

(22) Filed: Mar. 7, 2016

Related U.S. Application Data
(60) Provisional application No. 62/129,135, filed on Mar. 6, 2015.

(51) Int. Cl. G01S 13/88; H01Q 1/52; G01S 13/02

(52) U.S. Cl. CPC G01S 13/885; G01S 13/0209; H01Q 1/525

(57) ABSTRACT

An improved Ground Penetrating Radar (GPR) system is provided. The system advantageously employs full waveform digitization of a returning signal to significantly reduce the number of launch signals and allowing the amount of radiation emitted to stay within the limit set by the Federal Communications Commission (FCC), while producing a robust information detection signal. In addition, intermittent large latent-duty-cycle sampling employs a less expensive digitizer typically used in prior an GPRs. The system is scalable at low-cost to accommodate multi-antenna multi-static testing for subsurface tomographic imaging.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/129,135, entitled “Ultra Wideband Ground Penetrating Radar”, naming Dryver R. Huston as inventor, filed 6 Mar. 2015.

### BACKGROUND

1. Field of Use

The invention relates to ground penetrating radar systems for use in surveying pavement structure.

2. Description of Prior Art (Background)

Crumbling and unstable infrastructure in the United States has become an immediate threat to safety of citizens and critical to their identification and repairs is the use of ground penetrating radar systems to scan below the surface for the dangers present themselves to the unequipped observer.

Ground Penetrating Radar (“GPR”) systems are used to make measurements of different structures in the ground. These systems are also referred to as impulse ground penetrating radar (I-GPR) systems. Each system incorporates a transmitter having an antenna that radiates or emir a short pulse of radio frequency typically in the frequency range from 1 MHz to 10 GHz; into the sub-surface medium, GPR systems (compared to other radar systems) are characterized by being able to generate a pulse length which is short with respect to the wavelength of the center frequency being transmitted. In practice, a pulse of 1.0 to 2.0 cycles of the center frequency can be emitted.

Wherever there is a change in the electrical properties in the ground, part of the pulse is reflected and part of the pulse propagates into the next layer. Stated otherwise, waves or pulses are reflected by reflective interfaces defining upper and lower margins of a sub-surface layer or anomaly. The reflected pulses are detected at the antenna of a receiver.

There are basically two types of GPR antenna systems in use for surveying roadways. The most common antenna type is a transverse electromagnetic transmission line antenna or “horn” which transmits and detects radio wave energy, typically operating at center frequencies of 0.5 to 5 GHz. The horn antenna is elevated from the road surface to be most effective.

The second antenna type is a resistively loaded dipole system which typically operates at center frequencies of 2 GHz or less. The dipole antenna is usually put on or very near the ground surface and is now being moved from general geotechnical applications to road surveys. For this application the transmitting and receiving antennas are in contact or almost in contact with the road surface.

The resolution of detection of sub-surface layers or anomalies is a function of the pulse length, and hence of the radio frequency (or wavelength) of the radar signal. Shorter pulse lengths provide better resolution, and it is easier to achieve shorter pulse lengths with a higher center frequency system. Therefore, the horn antenna systems, which tend to operate at higher frequency, enable thinner layers to be resolved.

The depth of penetration through most materials is a function of the operating frequency (or wavelength). Typically, lower frequencies are able to penetrate with less attenuation. Also, better penetration into the ground is achieved when the antennas are coupled closely to the ground surface. Therefore, the surface-coupled antenna systems permit detection of features at deeper depths.

A horn antenna system operating at a center frequency of about 3 GHz can resolve layers as thin as 50 mm and can detect features to depths of 300 to 500 mm in typical materials. A surface-coupled antenna system operating at a center frequency of about 1 GHz can resolve layers as thin as 100 to 150 mm and can typically detect features to depths of 1 to 2 m.

Typical I-GPR receivers sample the entire waveform cycle, including the long idle times, either with lower-cost multiple-wave-cycle subsampling techniques or single-cycle full-wave digitization with expensive high-speed Analog-to-Digital Converters (ADCs).

I-GPR is useful for detecting and locating objects and subsurface features in large dielectric structures such as geological formations, glaciers, roadways and concrete structures. Subsurface features of interest include material layering, archeological sites, pipes, steel reinforcing, voids, cracking and more complicated forms of damage.

The operating procedure is a cyclic repetition of the following steps 1. Launch short-duration electromagnetic pulses to probe subsurface features, 2. Receive reflected and scattered waves as short duration transients, 3. Idle for a period that is minimally long enough to receive the return signals and is typically several times longer than that of the transient return pulses, 4. Process and store the received data in background operations, and 5. Repeat the cycle at a rate known as the Pulse Repetition Frequency (PRF).

FIG. 1 shows the timing of the source and received signals. Attractive features of ultra-wideband I-GPR systems include relatively simple system architecture, wide instantaneous bandwidth, and deep penetration and high-resolution capabilities.

Technical challenges are high speed and high dynamic range signal processing on both the launch and receive ends, managing large amplitude direct coupling signals between launch and receive antennas, and limiting the amount of radiated electromagnetic emissions for regulatory compliance.

Receiver design plays a crucial role for I-GPRs, it determines features of system performance, such as bandwidth, PRF, horizontal coverage, scanning speed, resolution and radiated power emission. The receiver should have a wide bandwidth and high sampling speed, in the order of Giga-samples per second (Gsps). Most modern receivers use an equivalent-time sampling technique, see FIG. 2a. The GPR launches a sequence of nominally identical pulses with sufficient idle time between pulses to receive the entire return transient pulses. The equivalent time receiver collects a single sample from each waveform and constructs a full waveform by stewing the sample time offset while sampling from a minimum of hundreds of launch and receive cycles.

Full waveform digitization is an alternative that can, in principle, collect the same amount of information with many fewer launch and receive cycles, perhaps even one, as shown in FIG. 2b. Full-wave sampling requires high-speed ADCs; and large-bandwidth post-digitization transmission, process and store operations.

Prior art I-GPR receivers sample the entire waveform cycle, including the long idle times, either with lower-cost multiple-wave-cycle subsampling techniques or single-cycle full-wave digitization with expensive high-speed Analog-to-Digital Converters (ADCs).

In light of the above there exists a need for waveform digitization of returning signals to extract useful detection information while significantly reducing the number of launch signals needed, thus allowing the amount of radiation emitted to stay within the limit set by the Federal Communications Commission (FCC).

### BRIEF SUMMARY

The present invention provides a real-time, full-wave, low-cost Application Specific Integrated Circuit (ASIC) as a sampling receiver for Ultra-Wideband (UWB) impulse Ground Penetrating Radar (I-GPR). The invention uses a sampling receiver design that takes advantage of the specific timing nature of I-GPR signals, i.e. cyclic equally-spaced trains of short-duration, large dynamic range and information-dense high-frequency signals followed by long periods of idle time with no significant information content.

An Application Specific Integrated Circuit (ASIC) on a small evaluation printed circuit card implements full-waveform sampling in an I-GPR receiver at a lower cost than conventional GPRs. The ASIC samples the short duration and information-laden portion of the input waveform at a high speed by temporarily storing the data in a discrete-time analog-amplitude memory buffer.

A low-cost modest-performance ADC digitizes the stored voltages at a slow rate during the idle time between pulses. The ASIC has six independent channels, each capable of a real-time sampling rate of 10-15 Giga-samples per second (GSPS) with an analog bandwidth of 15 GHz.

An impulse ground penetrating radar (GPR) system is provided. The GPR system includes a transmitter antenna for transmitting radar signal pulses and a pulser for pulsing the transmitter; The system includes a receiver antenna for receiving the reflected transmitted signal pulses and a sampling receiver for digitally sampling the reflected signal pulse. The system also includes a signal generator for synchronizing the pulser and the sampling receiver.

The invention is also directed towards a method for operating a ground penetrating radar. The method includes pulsing a transmitter to emit a radar frequency electromagnetic wave and receiving a reflected component of the emitted wave, wherein the reflected component includes a pulse time and idle time. The method digitally samples the reflected component during the pulse time and does not digitally sampling the reflected component during the idle time.

The invention is also directed towards an impulse ground penetrating radar (GPR) system. The GPR system includes a transmitter antenna for transmitting radar signal pulses and a pulser for pulsing the transmitter. The system also includes a receiver antenna for receiving the reflected transmitted signal pulses and a sampling receiver for digitally sampling the reflected signal pulse, wherein the sampling receiver includes a Giga Samples per Second (GSPS) sampling receiver. A signal generator synchronizes the pulser and the sampling receiver. In addition, the transmitter antenna and the receiver antenna comprise a pair of Good Impedance Match Antennas (GIMA).

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a graphical representation of a source and received pulse timing sequence in an impulse-GPR;

FIG. 1A is a schematic view of a ground penetrating radar system (GPR), mounted to a vehicle, positioned on a roadway;

FIGS. 2a and 2b are graphical representation illustrating a) equivalent sampling over multiple pulse cycles and b) real-time full wave sampling over a single cycle with fewer pulses required to sample the same information;

FIGS. 3a and 3b are graphical representations illustrating Full wave sampling: a.) Sampling of entire wave cycle including idle time that contains minimal information typical in the prior art; b) Sampling of information-laden short high frequency return pulse without sampling of idle time in accordance with the invention shown in FIG. 1A;

FIG. 4 is a block diagram of one example of architecture overview and functional control of an Application Specific Integrated Circuit (ASIC) and floating point gate array (FPGA) control;

FIG. 5 is a block diagram of the example shown in FIG. 4, using an ASIC;

FIG. 6 is a graphical representation illustrating Timing of trigger, pre-trigger sampling and trigger offset.

FIG. 7 is an operational schematic of an I-GPR receiverestbed example;

FIG. 8 is a pictorial illustration of a Good Impedance Matching Antenna;

FIGS. 9a, 9b, and 9c are graphical representations of ground penetrating examples of bistatic radar test configurations, in accordance with the invention shown in FIG. 1A: a. Antennas stationary over steel plate on concrete floor, b. Antennas stationary over bare concrete floor, and c. Antennas moving horizontally at constant speed with 25.4 mm steel cylinder on concrete floor;

FIGS. 10a, 10b, and 10c are graphical representations of examples of A-scan data from metal plate collected with a. PSEC4, b. Acqiris, and c. Overlay of PSEC4 and Acqiris using normalized amplitudes and time shift to align maximum values, in accordance with the invention shown in FIG. 1A;

FIGS. 11a and FIG. 11b are graphical representations of examples of B-scans collected from a bare concrete floor with the I-GPR testbed tow cart held stationary, a. B-scan of concrete floor repeats collected with PSEC4, and b. Acqiris B-scan of concrete floor, in accordance with the invention shown in FIG. 1A;

FIGS. 12a, 12b, and 12c are graphical representations of examples of comparison of time histories averaged over 500 nominally identical cycles: a. PSEC 4 mean time history±one standard deviation, b Acqiris mean time history±one standard deviation, c. overlay comparison of peak amplitude normalized and trigger time offset aligned mean time histories for the PSEC and Acqiris, in accordance with the invention shown in FIG. 1A;

FIG. 13a and FIG. 13b are graphical representations of examples of B-scans of two steel reinforcing bars on a concrete floor taken with a. PSEC-4 and b. Acqiris, in accordance with the invention shown in FIG. 1A;

FIG. 14a and FIG. 14b are graphical representations of examples of B-scans collected from two rebars on concrete floor while moving the I-GPR cart at constant speed producing hyperbolas, in accordance with the invention shown in FIG. 1A;

FIG. 15 is a flow chart for one method of operating a ground penetrating radar system in accordance with the invention shown in FIG. 1A;

FIG. 16 is a graphical representations of examples of top view geometry of multi-static test showing source to receive antenna direct coupling distances, in accordance with the invention shown in FIG. 1A; and

FIGS. 17a, 17b, and 17c are graphical representations of examples of transient time histories collected with antenna array in a multistatic configuration, in accordance with the invention shown in FIG. 1A.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

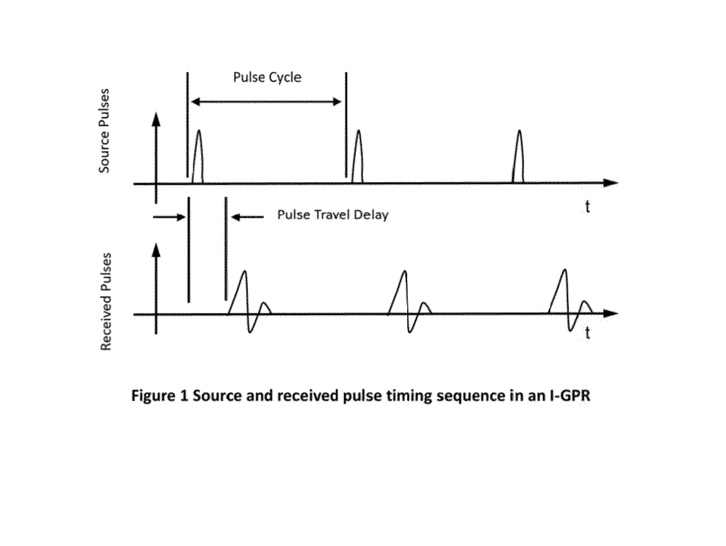

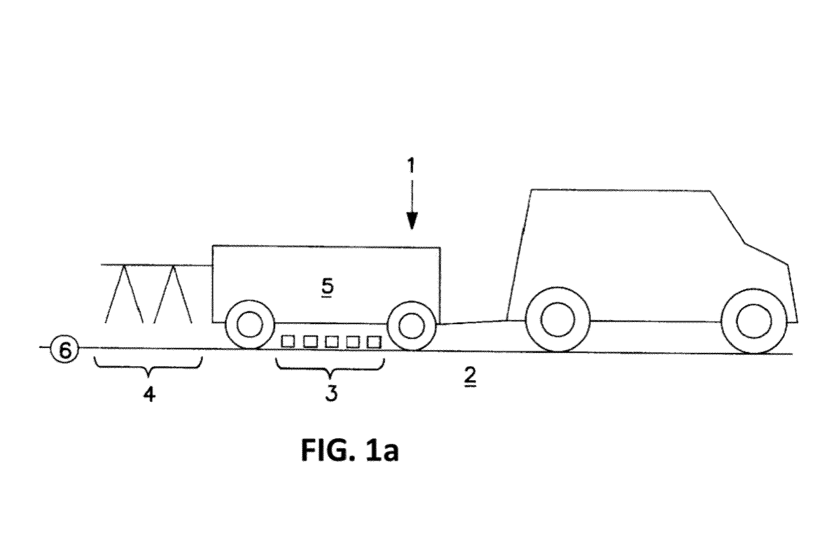

Referring to FIG. 1A, a ground penetrating radar (GPR) system 1 is provided as a non-destructive means for determining layer velocity, depth, thickness, and condition information relating to a roadway structure. (The term ‘roadway’ is to be broadly construed to denote roads, bridges and the like.)

The GPR system 1 comprises the combination of a surface-coupled assembly 5, wheel encoder 3, and an antenna or air-launched assembly 4 (including transmit and receive antennas), mounted on a vehicle or trailer 5 for transportation over the surface 6 of the roadway 2.

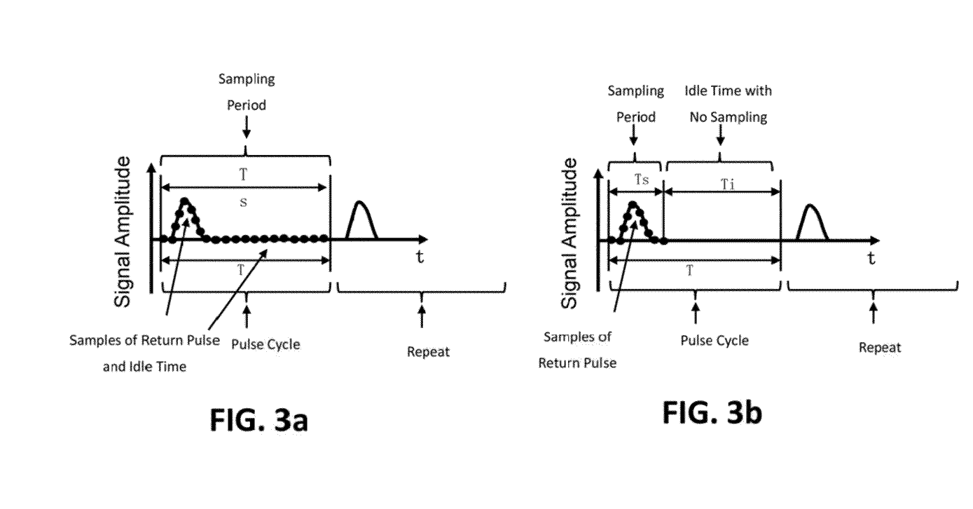

As shown in FIG. 3, I-GPR signals are sequences of repeated cycles, each of duration T=1/PRF. An individual cycle contains a short information-laden period of length, followed by a longer idle time. The idle times carry minimal information and normally do not require acquisition.

Partial-duty-cycle full-wave sampling reduces the bandwidth requirements of the receiver by minimizing idle-time sampling. In a conventional continuous streaming data acquisition system, the sampling period equals the entire pulse cycle, as in FIG. 3a. Partial-duty-cycle full-wave sampling collects data for only a short duration of the cycle period, Tₛ, then idles for a period, Tᵢ, such that

T=Tᵢ+Tₛ (1)

As shown in FIG. 3(b) the invention samples the input waveform at high resolution and high speed for the information laden short duration portion of the pulse collection cycle and avoids sampling during the idle time.

The digital data bandwidth, D_{BW}, in terms of bytes per time for a generic I-GPR receiver is

D_{BW}=N_{S}×PRF×N_{B} (2)

Ns is the number of samples/cycle and N_{B} is the number of bytes/sample. For sub sampling, N_{S}=1 and

D_{BW}(Sub sampling)=1×PRF×N_{B} (3)

For streaming full wave sampling of the entire waveform including idle time

D_{BW}(Fullware including idle)=N_{C}×PRF×N_{B} (4)

For partial duty-cycle full wave sampling of the return pulse without the idle time

$${D}_{BW} ( Fullwave without idle ) = {N}_{C} \times ( \frac{{T}_{s}}{T} ) PRF \times {N}_{B} \qquad ( 5 )$$

The reduction in bandwidth is proportional to the amount of the cycle dedicated to idling.

### EXAMPLE

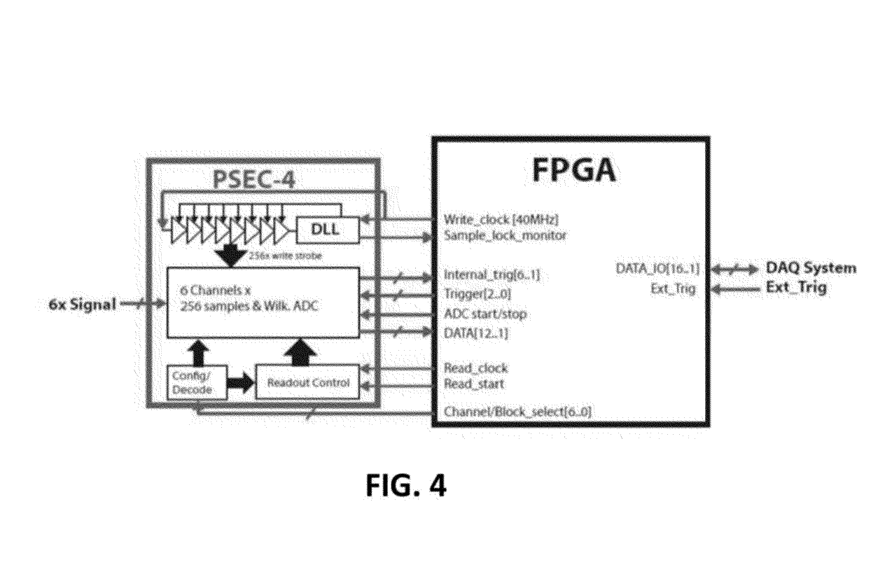

A receiver selected for implementing partial duty cycle real time full wave sampling was an evaluation board containing a single PSEC4 15 Giga Samples per Second (GSPS) analog-buffered full waveform sampling ASIC, see FIG. 4. The PSEC4 consists of six input channels each having a dedicated bank with a depth-count of 256 sample-and-hold switched capacitor circuits and one ADC.

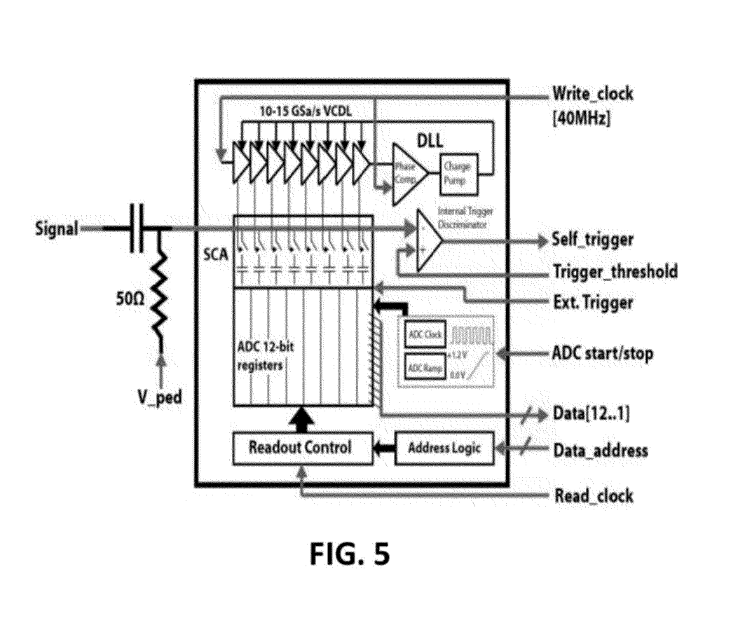

FIG. 5 shows an overview of the architecture of a single channel of PSEC4. For simplicity only 8 cells of the 256 analog memory cells are illustrated. The input signal is stored in the memory cells and digitized by the ADC and stored in 12-bit registers. The registers are read out after all the memory cells are digitized.

In this example an Evaluation Card uses a Cyclone III Altera FPGA (EP3C25Q240), a universal serial bus (USB) 2.0 interface, DC power input and a BNC external trigger connector.

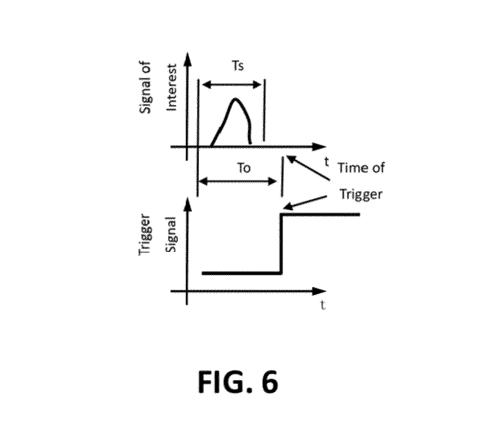

As shown in FIG. 6, the system samples the input waveform continuously and stores the data temporarily in a pre-trigger buffer by continually overwriting the analog data stored in the 256 sampling, SCA cells. The collected data consequently correspond to the waveform received prior to the receipt of the trigger signal, T₀ is the offset time between receipt of the trigger and start of the data sample buffer.

A custom I-GPR system served as a testbed for evaluating receiver performance. This testbed is capable of using either the PSEC4 waveform-sampling receiver or an Acqiris 10-bit 8 Giga Samples per Second (GSPS) 1.5 GHz bandwidth streaming receiver. The Acqiris is a commercially available system capable of sampling a single channel at 8 GSPS in a streaming mode that provides a baseline for comparison to the PSEC4. The internal architecture uses a gang of synchronized interleaved ADCs to achieve the high-speed continuous streaming sampling. The nominal performances of the Acqiris and PSEC4 are comparable, with the primary differences being the Acqiris can sample continuously, while the PSEC4 samples intermittently; and the Acqiris can sample only a single channel, while the PSEC4 can sample 6 channels with the possibility for scaling up to many more channels. It will be appreciated that any suitable waveform sampling receiver may be used.

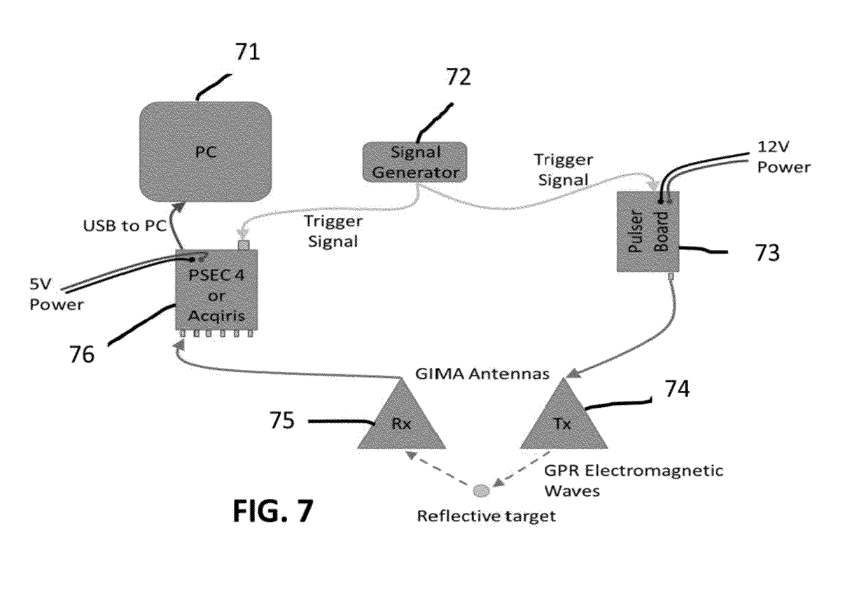

A schematic diagram of the testbed appears in FIG. 7. A square wave signal generator 72 running at a PRF of 50 kHz simultaneously sends a rising edge trigger signal to the sampling receiver 76 (Acqiris or PSEC4 in this example) and to a custom CMOS-based UWB pulser 73.

Still referring to FIG. 7, pulser 73 may be any suitable pulser meeting the requirements of Federal Communications Commission (hereinafter referred to as “FCC”) regulations for UWB technology.

Specifically, the FCC requires that transmitted UWB pulses should observe strict limitationsm terms of a pulse bandwidth and amplitude. The emissions of radio frequency devices generally are regulated by Part 15 of Title 47 of the Code of Federal Regulations (“C.F.R.”). Subpart F, in particular, entitled “Ultra-Wideband Operation,” and found at 47 C.F.R. §§15.501-15,525, recites regulations that specifically restrict the emissions of UWB devices. Among those regulations, the FCC sets forth frequency masks for UWB devices in particular applications, namely “ground penetrating radars and wall imaging systems” (§15.509); “through-wall imaging systems” (§15.510); “surveillance systems” (15.511); “medical imaging systems” (§15.513); “vehicular radar systems” (§15.515); “indoor UWB systems” (15.517); and “hand held UWB systems” (§15.519). These frequency masks are incorporated herein by reference. Further limitations and measurement requirements are set forth in §15.519, “Technical requirements applicable to all UWB devices,” also incorporated herein by reference.

In one embodiment, pulser 73 may include four Gaussian-like pulse generators that generate pulses at different time offsets. The resulting four Gaussian-like pulses are combined to generate a UWB pulse that approximates the fifth derivative of a Gaussian pulse.

In another embodiment, pulser 73 may include a sequence control stage, a pulse generation stage, and an output stage. The sequence control stage receives a pulse enable signal and generates output signals with different time offsets at a plurality of output branches. The pulse generation stage includes a plurality of pulse generators, wherein each pulse generator is coupled to an output branch of the sequence control stage and generates a Gaussian-like pulse at its respective time offset. The output stage combines the generated pulses into an ultra-wideband pulse. Preferably, the pulses are timed in such a way as to approximate a derivative of first or higher order of the Gaussian pulse. In one embodiment, four Gaussian-like pulses may be combined to approximate the fifth derivative of the Gaussian pulse.

The tests initially were a bi-static configuration, i.e. a single source antenna and a separate single receive antenna. A pair of Good Impedance Match Antennas (GIMA) 74,75 transmitted and received the signals. Good Impedance Matching Antenna (GIMA), has been developed for use in Ground Penetrating Radar (GPR) NDE of concrete structures. The requirements of a useful GPR antenna are that it provides sufficient penetrating depth in the concrete with sufficient resolution to determine the location and magnitude of the defects, such as deterioration and delamination. The GIMA antenna is designed to have a self-defined aperture that minimizes impedance mismatching at the aperture. This unique feature allows the antenna to be used in various frequency bands. The tested frequency range is from 500 MHz to 16 GHz. The antenna provides a high penetrating depth (more than 330 mm) and the sufficient resolution of the image that can recognize cracks up to 1 nun thick, with a radiation coefficient of about 99%. In addition, the aperture reflection is determined via the time-domain air shot reflections.

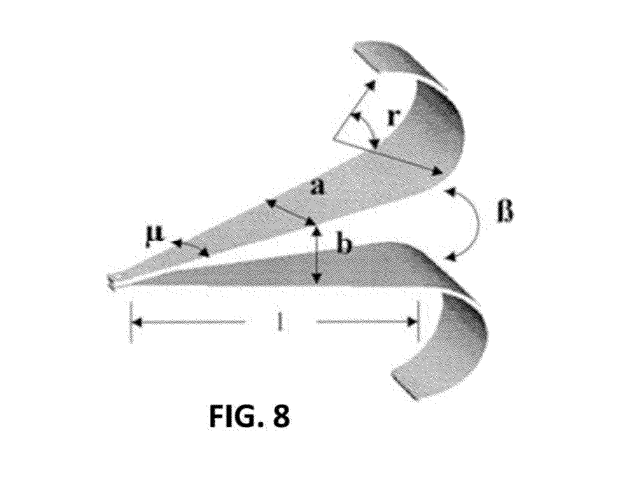

To have the maximum power transmitted onto the object under inspection, the GPR antennas need to have good impedance matching to minimize the internal reflections and to smooth out the transition from the circuit impedance, 50 V, to the free space impedance, 377 V. As shown in FIG. 8, the GIMA antennas (FIG. 7-74,75) appears as a waveguide with two metal conductors of varying widths that are separated by an insulator. FIG. 8 illustrates the shape and the critical dimensions of the GIMA antenna where μ=13⁰, β=6⁰, r=150⁰, a=60 mm, b=60 mm, and 1=180 mm.

A computing device 71 offloads the data from the sampling receiver 76 via a data link—Ethernet for the Acqiris and USB for the PSEC4. It will be understood that any suitable datalink may be used, for example Bluetooth or other wireless datalinks may be used.

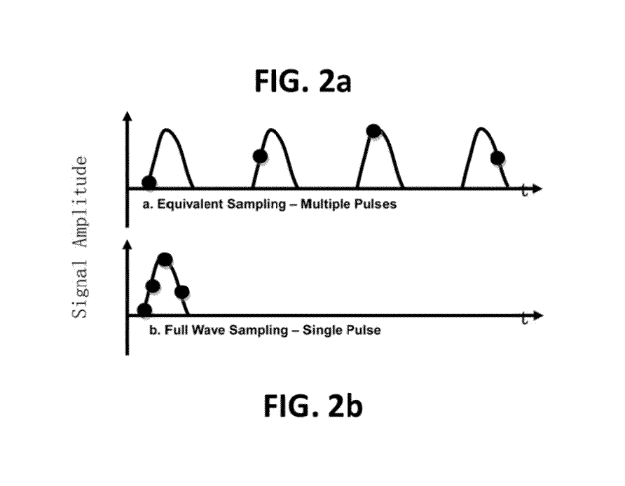

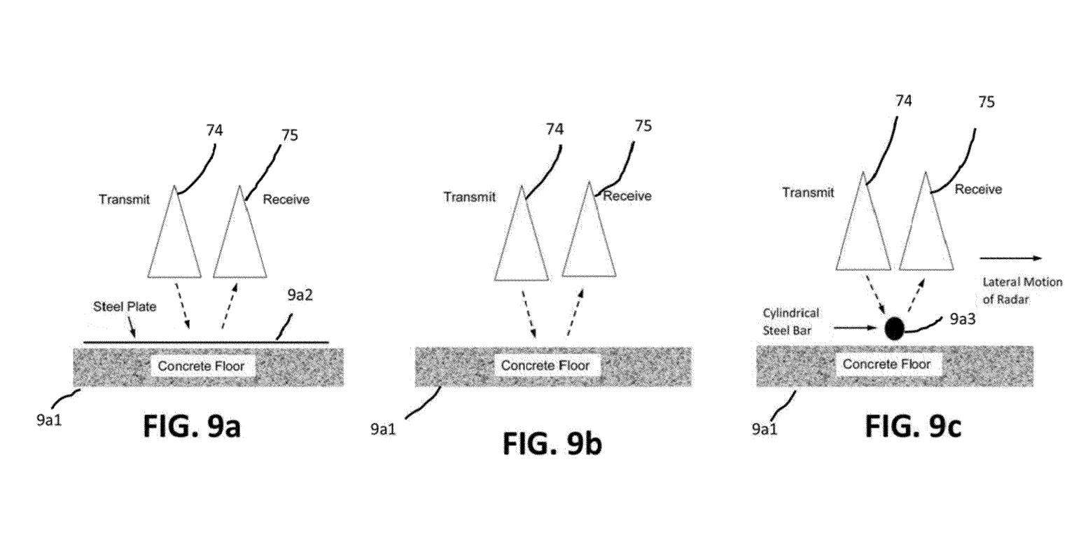

The testbed fits into a small vehicular tow trailer, (see FIGS. 1A-5). The system 1 collected data in three different bi-static target configurations, as shown in FIG. 9: a. Metal plate 9a2 resting on concrete floor 9a1; b. Bare concrete floor 9a1; and, c. 25.4 mm diameter steel bar 9a3 resting on concrete floor 9a1 with the transmit 74 and receive 75 radar in constant velocity horizontal movement.

Initial tests measured individual time domain traces, i.e. A-scans, of the reflections off of the metal plate 9a2 placed under the system 1, in the setup of FIG. 9a.

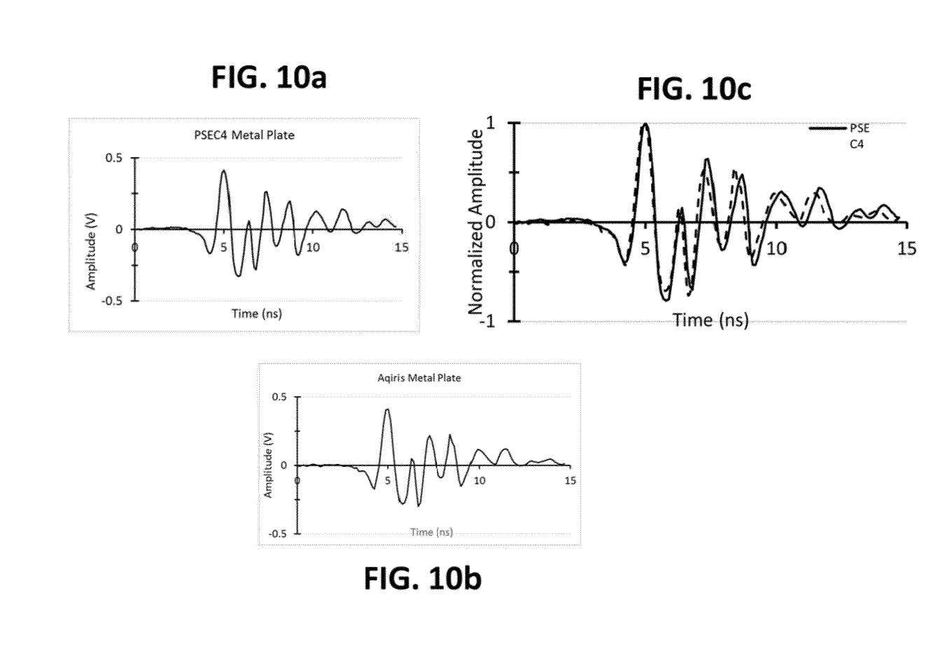

FIGS. 10a and 10b show typical A-scan data collected b the PSEC4 and Acqiris, respectively, under nominally identical conditions. FIG. 10c is an overlay of the two A-scan traces, with the time shifted and amplitudes normalized to match the maximum amplitude points occurring at 5 ns.

The next series of tests examined the cyclic acquisition capabilities of the receivers. The tests collected a series of time traces as the system 1 is in either a stationary or slowly-varying configuration. The B-scan is a condensed image-based representation of a set of A-scan traces. Each individual column in the B-scan image contains the data of a single A-scan with positive time flowing down and the amplitude encoded on a gray scale from white to black.

The initial B-scan measurements placed the antenna stationary above a concrete floor 9a9 , as in FIG. 9b, and collected data from a set of 500 cycles under nominally identical conditions. An initial examination of the data found that the PSEC4 has a cyclic variation in the trigger timing offset. This variation was identified and removed in software using the direct-coupling peak, i.e. first large amplitude peak, in the signal as a timing landmark.

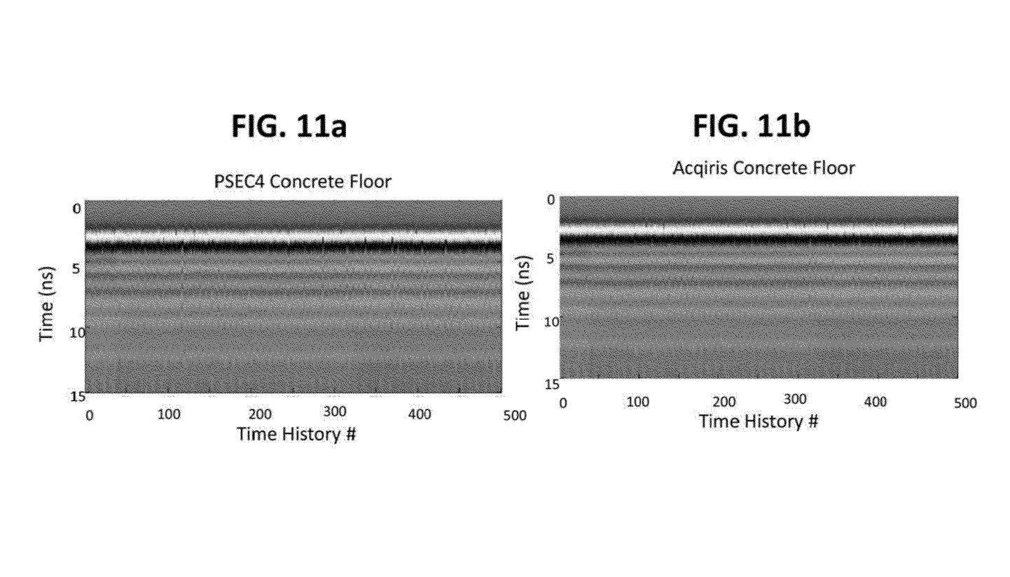

FIG. 11 shows a B-scan of the data collected with the PSEC4. The bright white line corresponds to the direct coupling signal. FIG. 11b shows a B-scan collected with the Acqiris, under nominally identical test conditions. Further analysis of this data set evaluated the repeatability and noise in the measurement systems by first calculating the mean of the time histories across the repeats and then the standard deviation.

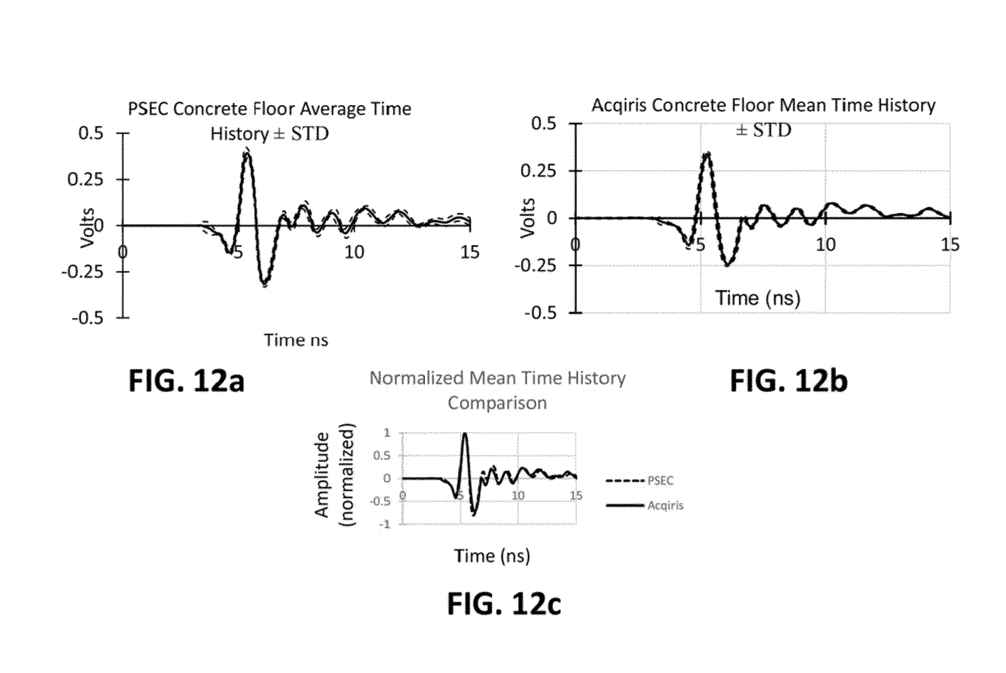

Referring also to FIGS. 12a-c, there is shown a comparison of time histories averaged over 500 nominally identical cycles: FIG. 12a and FIG. 12b show the mean time history and the mean time history±one standard deviation for the PSEC4 and Acqiris systems, respectively. FIG. 12c is an overlay of the amplitude normalized and time shift aligned mean time histories for the PSEC4 and Acqiris.

The next set of tests evaluated the capability of the receivers to detect isolated features. The test protocol was to place two no. 6 steel reinforcing bars (nominal diameter of 79.1. mm ( 6/8in.)) on a concrete floor and to collect I-GPR data while manually towing the cart FIGS. 1A-5 at a walking pace over the rebars, collecting a sequence of A-scan traces, assembling into a B-scan, and conditioning the B-scans by removal of the background traces.

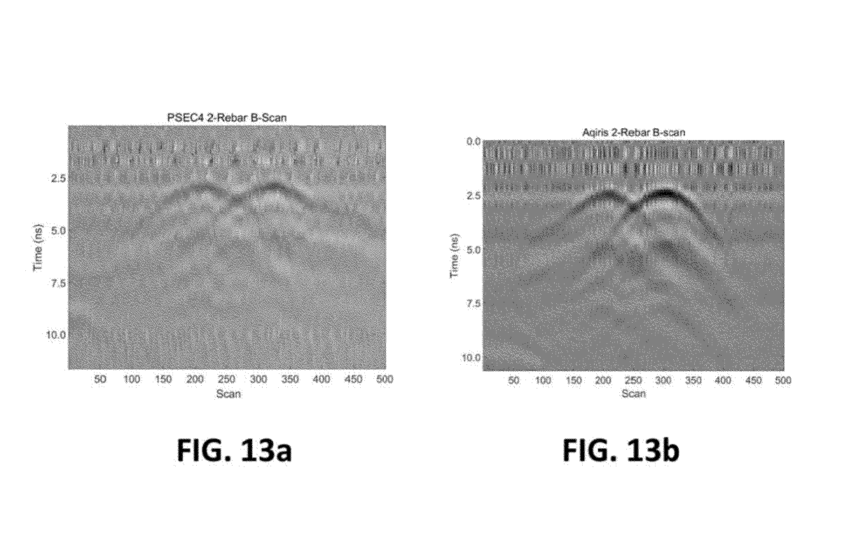

Typical results appear in FIG. 13a and FIG. 13b with a. PSEC4 and b. Acqiris. Hyperbolas corresponding to the individual bars are visible in both images. A visual examination indicates that the hyperbolas from the Acqiris are a smoother and more symmetric than those from the PSEC4. This is likely a consequence of the difference in triggering modes between the systems.

The Acqiris data collection used the wheel encoder (FIGS. 1-3) to trigger pulse and data acquisition cycles. The PSEC4 data acquisition used fixed time intervals for triggering and was subject to variability in walking speeds. The B-scan from the Acqiris had a moderately better contrast than the PSEC4. Calculating image statistics in terms of histogram, standard deviation and entropy provides some more insight into the contrast and texture of images. Both B-scans used a 0-255 gray scale intensity representation.

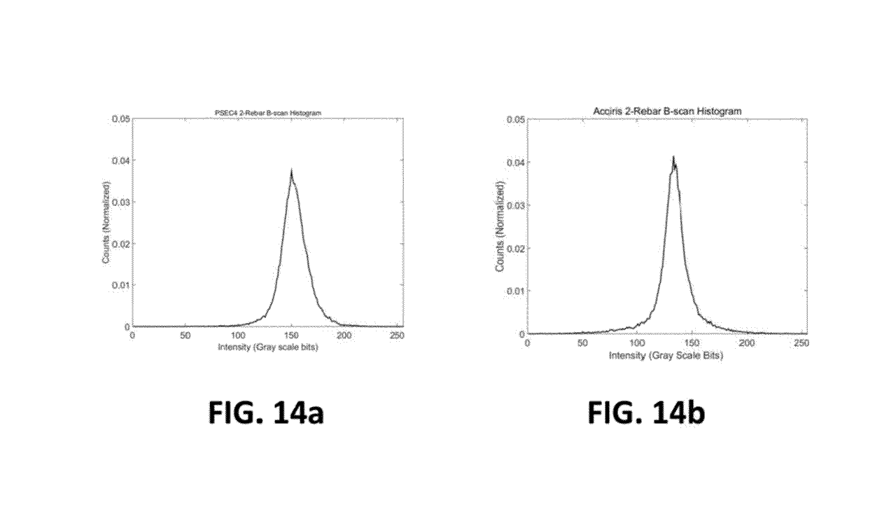

FIG. 14a and FIG. 14b show the intensity histograms for the images with a. PSEC4 and b. Acqiris. The mean, standard deviation, and image entropy of the B-scan intensities are 151.9 14.9 and 2.98e-04 for the PSEC4; and 132.8, 19.0 and 3.96e-04 for the Acqiris; respectively. The standard deviation is a measure of the dynamic range spread of the data, with larger standard deviations corresponding to a larger use of the available dynamic range of the instrument. The entropy is a measure of the texture in the signal with larger values of entropy corresponding to increased amounts of texture in the image.

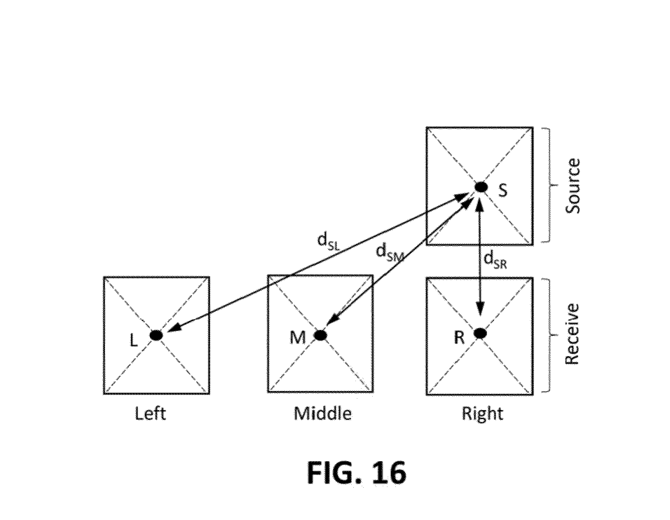

The final series of tests evaluated the multichannel receiver performance of the PSEC4 with multi-static single antenna launch and three-antenna receive measurements. FIG. 16 shows the antenna configuration with the launch antenna placed asymmetrically with a lateral offset to the right relative to a linear array of three receive antennas: dSL=115 mm, dSM=75 mm, and dSR=50 mm The corresponding dimensions appear in FIG. 16. Upon launching a single pulse from the source antenna, the signal travels through direct coupling and surface reflection paths of different lengths according to receiver antenna position relative to the launch antenna. The PSEC4 collects the A-scan traces from the three antennas as full wave forms simultaneously, i.e. in a multi-static configuration.

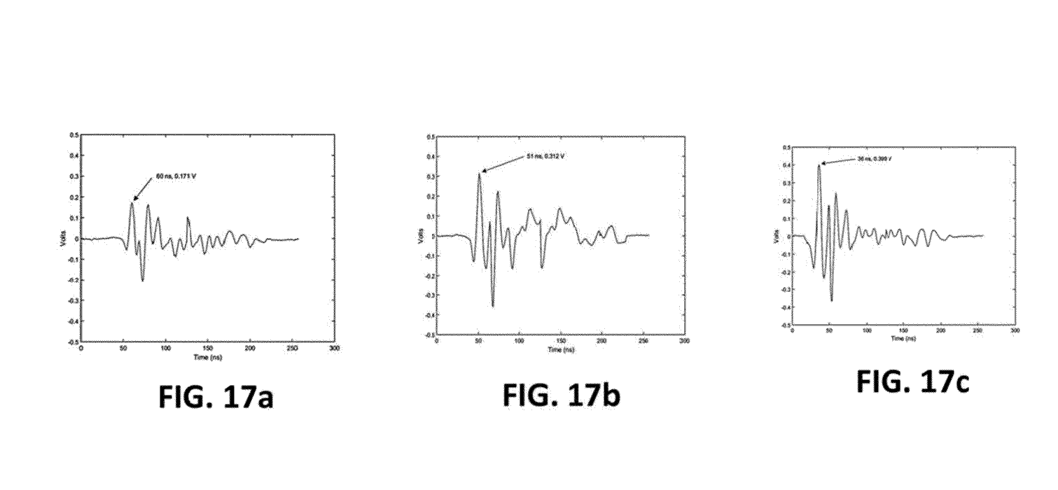

The results appear in FIG. 17 with the amplitude of the received signal decaying and the time delay of arrival increasing with the distance of the source to the receive antenna. Transient time histories collected with antenna array in a multistatic configuration shown in FIG. 16 measures full waveforms simultaneously for reflection from a concrete floor with a steel reinforcing bar target (e.g., as shown in FIG. 9). The initial peak noted with time and amplitude is due to direct coupling between source and receive antennas: a. left antenna, b. middle antenna and c. right antenna.

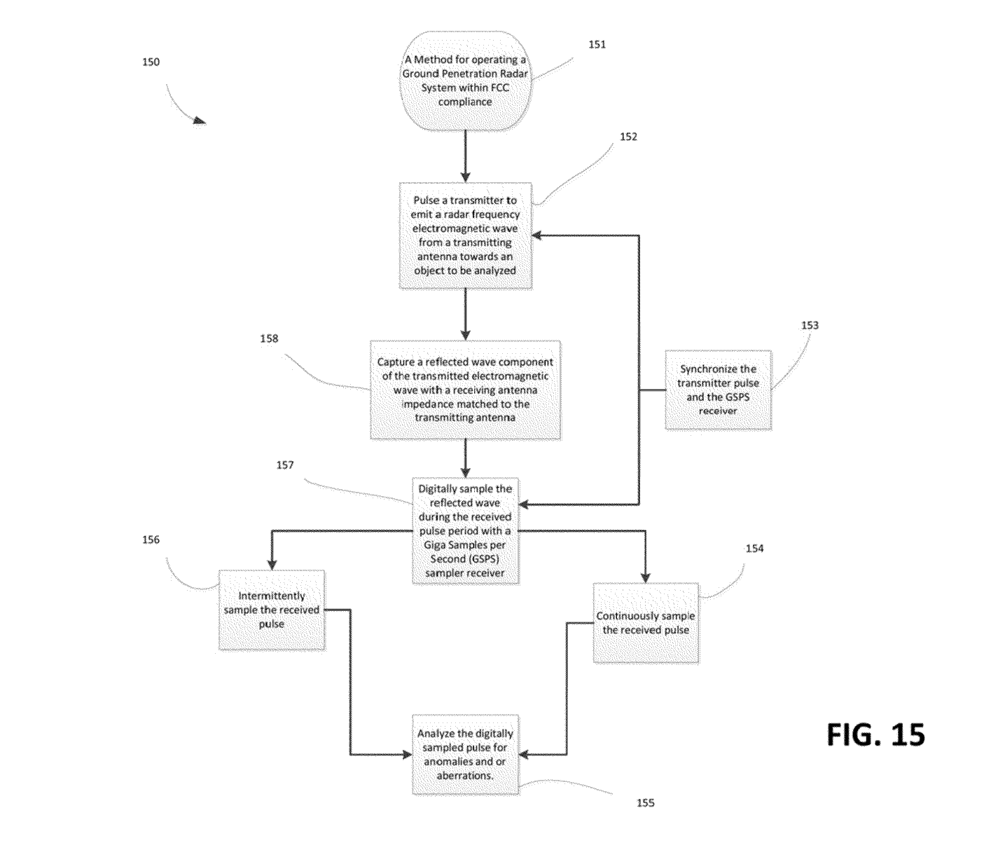

Referring also to FIG. 15 there is shown a flow chart for one method 150 of operating a ground penetrating radar system in accordance with the invention shown in FIG. 1A. a transmitter is pulsed to emit a radar frequency electromagnetic wave from a transmitting antenna towards an object to be analyzed 152. A reflected wave component of the transmitted electromagnetic wave is received or captured with a receiving antenna impedance matched to the transmitting antenna 158. Next, digitally sample the reflected wave during the received pulse period with a Giga Samples per Second (GSPS) sampler receiver 157.

Synchronize the transmitter pulse and the GSPS sampling receiver 153. It will be understood that any suitable method for synchronization may be used. Such as, for example, fixed time intervals or mechanical methods such as a wheel encoder as shown in FIG. 1A.

In one embodiment, continuously sample the received pulse 154 and in an alternate embodiment intermittently sample the received pulse 156. Analyze 155 the digitally sampled pulse for anomalies and or aberrations, such as, for example concrete fractures, voids, or rebar condition.

It will be appreciated that novel features of a low cost, real-time full waveform sampling ASIC test card as a UWB I-GPR receiver is disclosed herein. In comparison with prior art the invention disclosed herein offers the following advantages and features: 1. An invention utilizing discrete analog buffers combined with a slow rate ADC to achieve single shot high resolution full waveform sampling. The invention avoids using multiple pulse signal cycles to construct just one output pulse signal and avoids using an expensive high-speed streaming ADC system; 2. The single-shot real-time sampling feature with six channel receivers per ASIC, expandable to multiple ASICS, enables wide horizontal detection coverage during GPR surveys.

it should be understood that the foregoing description is only illustrative of the invention. Thus, various alternatives and modifications can be devised by those skilled in the art without depaning from the invention. Accordingly, the present invention is intended to embrace all such alternatives, modifications and variances that fall within the scope of the appended claims.

What is claimed is:

1. An impulse ground penetrating radar (GPR) system, the GPR system comprising:
a transmitter antenna for transmitting radar signal pulses;
a pulser for pulsing the transmitter;
a receiver antenna for receiving the reflected transmitted signal pulses;
a sampling receiver for digitally sampling the reflected signal pulse; and
a signal generator for synchronizing the pulser and the sampling receiver.

2. The system as in claim 1 further comprising a computing device connectable to the sampling receiver.

3. The system as in claim 1 wherein the transmitter antenna and the receiver antenna comprise a pair of Good Impedance Match Antennas (GIMA).

4. The system as in claim 1 further comprising a wheel encoder, wherein the wheel encoder triggers pulsing and receiving cycles.

5. The system as in claim 1 wherein the sampling receiver comprises an intermittent sampler.

6. The system as in claim 5 wherein the intermittent sampler comprises a six channel sampling receiver.

7. The system as in claim 6 wherein the six channel sampling receiver comprises a substantially 15 Giga Samples per Second (GSPS) sampling receiver.

8. The system as in claim 1 wherein the sampling receiver comprises a continuous sampler.

9. The system as in claim 8 wherein the sampling receiver comprises a one channel sampling receiver.

10. The system as in claim 9 wherein the one channel sampling receiver comprises a substantially 8 Giga Samples per Second (GSPS) sampling receiver.

11. The system as in claim 1 further comprising a plurality of receivers.

12. A method for operating a ground penetrating radar, the method comprising:
pulsing, a transmitter to emit a radar frequency electromagnetic wave;
receiving a reflected component of the emitted wave, wherein the reflected component comprises a pulse time and idle time;
digitally sampling the reflected component during the pulse time; and
not digitally sampling the reflected component during the idle time.

13. The method as in claim 12 wherein digitally sampling the reflected component during the pulse time further comprises digitally sampling the reflected component with a Giga Samples per Second (GSPS) sampling receiver.

14. The method as in claim 13 wherein digitally sampling the reflected component further comprises intermittently sampling the reflected component during the pulse time.

15. The method as in claim 13 wherein digitally sampling the reflected component further comprises continuously sampling the reflected component during the pulse time.

16. The method as claim 12 further comprising synchronizing the pulsing of the transmitter and the digital sampling of the reflected component.

17. The method as in claim 12 further comprising analyzing the digitally sampled reflected component for aberrations.

18. An impulse ground penetrating radar (GPR) system, the GPR system comprising:
a transmitter antenna for transmitting radar signal pulses;
a pulser for pulsing the transmitter;
a receiver antenna for receiving the reflected transmitted signal pulses;
a sampling receiver for digitally sampling the reflected signal pulse, wherein the sampling receiver comprises:
a Giga Samples per Second (GSPS) sampling receiver;
a signal generator for synchronizing the pulser and the sampling receiver; and
wherein the transmitter antenna and the receiver antenna comprise a pan of Good Impedance Match Antennas (GIMA).

19. The system as in claim 18 wherein the sampling receiver comprises a continuous sampler.

20. The system as in claim 8 wherein the sampling receiver comprises an intermittent sampler.
